(19) United States
(12) Patent Application Publication
(10) Pub. No.: US 2004/0091645 A1
(43) Pub. Date: May 13, 2004

(54) Topcoat compositions, substrates containing a topcoat derived therefrom, and methods of preparing the same

(76) Inventors: Peter Johannes Heederik, RE Leiden (NL); Jan-Willem Sleve, CW Hazerswoude-Rijndijk (NL)

Correspondence Address: William C Tritt, Renner Otto Boisselle & Sklar, 19th Floor, 1621 Euclid Avenue, Cleveland, OH, 44115, US

(21) Appl. No.: 10/467,045

(22) PCT Filed: Feb. 5, 2001
(86) PCT No.: PCT/US01/03668

(51) Int. Cl. B32B 3/00

(52) U.S. Cl. 428/32.1

(57) ABSTRACT

This invention relates to a coating composition comprising (a) at least one binder and (b) at least one filler having a surface area of at least about 1 m²/g and wherein a topcoat derived from the coating composition is printable with a UV curable ink-jet ink. The invention also relates to an article with an ink receptive printing layer, comprising a substrate having a topcoat, wherein the topcoat is printable with UV curable ink-jet inks. The topcoats provide a printable surface for UV curable ink-jet inks. The print shows superior liquid resistance. The print quality of the UV curable inks is improved and a reduction in bleeding of colors occurs.

### FIELD OF THE INVENTION

This invention relates to ink-receptive topcoats, especially topcoats which are receptive to UV curable ink-jet inks.

### BACKGROUND OF THE INVENTION

Ink-jet technology utilizes a liquid based delivery system in which the ink pigments or dyes are delivered to a substrate together with a liquid. The substrate usually has a topcoat which contains at least one absorbent material to remove the liquid of the ink-jet ink. The conventional ink-jet printing technology is based on liquid based inks, such as water, solvent or oil based inks. Typically the coatings include resins and/or fillers which are able to swell and absorb liquid. Examples of these resins include gelatin, polyvinyl pyrrolidone, and polyvinyl alcohol.

UV-cured ink-jet printing is a relatively new printing technology that uses inks that are cured by ultraviolet radiation. Unlike ink-jet inks, no liquid, such as water, solvent or oil, is necessary as a carrier for the dyes or pigments of the inks. Accordingly, no strong absorbing coatings or additional thermal drying steps are necessary to set these UV curable inks on the printing medium. UV ink-jet prints have superior liquid resistance that reaches the level of the standard printing techniques, such as screen and flexoprinting.

However, one problem with UV curable ink-jet inks is the quality of the print strongly depends on the nature of the substrate. Smooth non-absorbing surfaces result in poor print quality. Additional problems with UV curable inks are uneven ink coverage and bleeding of colors. A need exists for a topcoat that provides a good medium for the UV curable ink-jet inks.

### SUMMARY OF THE INVENTION

This invention relates to a coating composition comprising a) at least one binder and b) at least one filler having a surface area of at least about 1 m²/g and wherein a topcoat derived from the coating composition is printable with a UV curable ink-jet ink. The invention also relates to an article with an ink receptive printing layer, comprising a substrate having a topcoat, wherein the topcoat is printable with UV curable ink-jet inks. The topcoats provide a printable surface for UV curable ink-jet inks. The print shows superior liquid resistance. The print quality of the UV curable inks is improved and a reduction in bleeding of colors occurs.

### DETAILED DESCRIPTION OF THE INVENTION

This invention relates to a coating composition comprising a) at least one binder and b) at least one filler having a surface area of at least about 1 m²/g and wherein a topcoat derived from the coating composition is printable with a UV curable ink-jet ink. As noted herein, the present invention provides a topcoat for UV curable ink-jet inks. These inks are known to those in the art and include UV curable ink-jets, such as those commercially available and prepared by Sericol, Xaar, and Barco.

The topcoat composition will generally have a thickness from about 0.01 to about 20, or from about 0.5 to about 15, or from about 1 to about 10 g/m². Here, as well as elsewhere in the specification and claims, all range and ratio limits may be combined. The topcoat composition comprises a binder and a filler.

Binders

The binder may be any film forming monomer, oligomer or polymer or combinations thereof. Examples of useful binders include polyurethanes, polyacryls, polymethacryls, thermoplastic polymers of ethylene and propylene, ionomers, polyesters, polyamides, polyvinyl alcohols, polyvinyl pyrrolidinones, polyolefins, proteins, including gelatins, cellulosic resins including starches, rubbers, vinyl acetate homopolymers and co- or terpolymers, polystyrenic resins, and combinations and blends of two or more thereof. Generally the binder is present in a major amount. Typically the binder composition is present in an amount from about 40% to about 90%, or from about 50% to about 85%, or from about 55% to about 75% by weight of the solids of the coating composition.

In one embodiment, binder is a film-forming polymer, such as polyurethanes, polyacryls, polymethacryls, polyurethane-polyacryl mixtures, polyurethane-polymethacryl mixtures, urethane-acrylate or methacrylate copolymers, and mixtures thereof. As used herein, a “polyacryl” includes a polyacrylate, polyacrylic, or polyacrylamide. As used herein, a “polymethacryl” includes a polymethacrylate, polymethacrylic, or polymethacrylamide.

In one embodiment, the binder is a polyurethane. The polyurethane is typically the reaction products of the following components: (A) a polyisocyanate having at least two isocyanate (—NCO) functionalities per molecule with (B) at least one isocyanate reactive group such as a polyol having at least two hydroxy groups or an amine. Suitable polyisocyanates include diisocyanate monomers, and oligomers. Aliphatic polyisocyanates include 1,6-hexamethylene diisocyanate (HMDI) and its isocyanurate-containing derivatives; cycloaliphatic polyisocyanates such as 4,4′-methylene bis(cyclohexyl isocyanate) (H.sub.12 MDI), cyclohexane 1,4-diisocyanate and its isocyanurate derivatives; aromatic polyisocyanates such as 4,4′-diphenylmethane diisocyanate (MDI), xylyene diisocyanate (XDI), toluene diisocyanate (TDI), isophorone diisocyanate (IPDI), 1,5-naphthalene diisocyanate (NDI), 4,4′,4″-triphenylmethane diisocyanate, and their isocyanurate-containing derivatives. Mixtures or the reaction products of polyisocyanates can be used. Polyisocyanates contain the reaction products of these diisocyanate including isocyanurate, urea, allophanate, biuret, carbodiimide, and uretonimine entities.

Examples of polyisocyanates include ethylene diisocyanate, 1,4-tetramethylene-diisocyanate, 1,6-hexamethylene diisocyanate (HDI), 1,12-dodecane diisocyanate, cyclobutane, 1,3-diisocyanate, 1-isocyanato-3,3,5-trimethyl-5-isocyanato methyl cyclohexane, bis(4-isocyanato cyclohexyl)methane, isophorone diisocyanate (IPDI), bis(4-isocyanatocyclohexo)methane; 4,4′-methylene-dicyclohexyl diisocyanate; 1,6-diisocyanato-2,2,4,4-tetramethylhexane; 1,6-diisocyanato-2,4,4-trimethylhexane; cyclohexane-1,4-diisocyanate; etc. Desmodur H® from Miles Inc. is described as HDI having an NCO content of 50%, and Desmodur W from Miles Inc. is described as bis (4-isocyanato-cyclohexyl)methane containing 32% of NCO.

In another embodiment, the isocyanate reactive group is a polyol. The polyol (B) may be selected from those commonly found in polyurethane manufacturing. They include hydroxy-containing or terminated polyesters, polyethers, polycarbonates, polythioethers, polyolefins, and polyesteramides. Suitable polyester polyols include hydroxy-terminated reaction products of ethylene glycol, propylene glycol, diethylene glycol, neopentyl glycol, 1,4-butanediol, furan dimethanol, polyether diols, or mixtures thereof, with dicarboxylic acids or their ester-forming derivatives. Polyesters obtained by the polymerization of lactones, such as caprolactone may also be used.

Polyether polyols useful for the polyurethane reaction include products obtained by the polymerization of a cyclic oxide including ethylene oxide, propylene oxide or tetrahydrofuran, or mixtures thereof. Polyether polyols include polyoxypropylene (PPO) polyols, polyoxyethylene (PEO) polyols, poly(oxyethylene-co-oxypropylene) polyols, polyoxytetramethylene (PTMO) polyols.

Polycarbonate polyols useful for the polyurethane reaction include the products represented by the reaction products obtained by reacting diols such as 1,3-propanediol, 1,4-butanediol, 1,5-pentanediol, 1,6-hexanediol, diethylene glycol with diaryl carbonates such as diphenyl carbonate, or with phosgene, or with aliphatic carbonate, or with cycloaliphatic carbonate. Commercial polycarbonate diols include Duracarb 120 series aliphatic diols and Durocarb 140 series cylco aliphatic diols, both of PPG Industries.

In another embodiment, (B) the isocyanate reactive group may be of ionic, ionic precursor or nonionic type. The isocyanate-reactive group include those compounds containing active hydrogen such as diols, polyols, diamines, and polyamines. The isocyanate reactive groups inlcude anionic and cationic types. Anionic types include dihydroxy carboxylic acids such as alpha, alpha-dimethylolpropionic acid (DMPA), diamino carboxylic acids such as 1-carboxy, 1,5-diaminopentane, and 2-(aminoethyl) aminoethyl carboxylic acid; and sulfonate diamines. Anionic type of hydrophilic groups may be the ones that readily form the salts of sulpho, sulfate, thiosulphato, phospho, phosphono, phosphato, or carboxy groups. Examples for cationic type include tertiary amino groups or precursors which readily form salts such as quaternary ammonium, quaternary phosphonium or ternary sulphonium salt groups.

Specific examples of the compounds containing ionic precursor groups and two or more isocyanate-reactive groups include triethanolamine, N-methyldiethanolamine and their oxyalkylation and polyeserification products, trimethylolpropane monophosphate and monosulphate, bis-hydroxylmethyl-phosphonic acid, diaminocarboxylic acids including lysine, cystine, 3,5-diamino benzoic acid, 2,6-dihyroxybenzoic acid, and dihydroxyalkanoic acids including 2,2-dimethylolpropionic acid.

Where a hydrophilic group is unreacted in preparing a polyurethane then a neutralizing compound for the hydrophilic group may be added to the reaction. Amines or ammonia such tertiary amines, such as triethylamine, triethanolamin or N-methylmorpholine, and diethyl amine or triethylamine, are effective in neutralizing carboxylic group and yields a neutralized anionic hydrophilic site on the polyurethane. In one embodiment, a chain extender that reacts with the excess or available isocyanate groups in the presence of aqueous medium and leads to a high molecular weight polyurethane aqueous dispersion. Suitable chain extenders for the further polymerization in aqueous medium are well known in the art. Selected examples include ethylene diamine, diethylene triamine, trietheylene tetraamine, propylene diamine, butylene diamine, hexamethylene diamine, cyclohexylene diamine, piperazine, tolylene diamine, xylylene diamine and isophorone diamine.

Useful polyurethanes include aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. Particularly useful polyurethanes include aromatic polyether polyurethanes, aliphatic polyether polyurethanes, aromatic polyester polyurethanes, and aliphatic polyester polyurethanes.

Examples of commecial polyurethanes include Sancure 2710® and/or Avalure UR 445® (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure 878®, Sancure 815®, Sancure 1301®, Sancure 2715®, Sancure 1828®, Sancure 2026®, Sancure 1818®, Sancure 853®, Sancure 830®, Sancure 825®, Sancure 776®, Sancure 850®, Sancure 12140®, Sancure 12619®, Sancure 835®, Sancure 843®, Sancure 898®, Sancure 899®, Sancure 1511®, Sancure 1514®, Sancure 1517®, Sancure 1591®, Sancure 2255®, Sancure 2260®, Sancure 2310®, Sancure 2725®, and Sancure 12471® (all of which are commercially available from BFGoodrich, Cleveland, Ohio), Bayhydrol DLN (commercially available from Bayer Corp., McMurray, Pa.), Bayhydrol LS-2033 (Bayer Corp.), Bayhydrol 123 (Bayer Corp.), Bayhydrol PU402A (Bayer Corp.), Bayhydrol 110 (Bayer Corp.), Witcobond W-320 (commercially available from Witco Performance Chemicals), Witcobond W-242 (Witco Performance Chemicals), Witcobond W-160 (Witco Performance Chemicals), Witcobond W-612 (Witco Performance Chemicals), Witcobond W-506 (Witco Performance Chemicals), NeoRez R-600 (a polytetramethylene ether urethane extended with isophorone diamine commercially available from Avecia, formerly Avecia Resins), NeoRez R-940 (Avecia Resins), NeoRez R-960 (Avecia Resins), NeoRez R-962 (Avecia Resins), NeoRez R-966 (Avecia Resins), NeoRez R-967 (Avecia Resins), NeoRez R-972 (Avecia Resins), NeoRez R-9409 (Avecia Resins), NeoRez R-9637 (Avecia), NeoRez R-9649 (Avecia Resins), and NeoRez R-9679 (Avecia Resins).

Particularly useful polyurethanes are aliphatic polyether polyurethanes. Examples of such aliphatic polyether polyurethanes include Sancure 2710® and/or Avalure UR 445®, Sancure 878®, NeoRez R-600, NeoRez R-966, NeoRez R-967, and Witcobond W-320.

In one embodiment, the binder is polyester polyurethane. Examples of these binder include those sold under the names “Sancure 2060” (polyester-polyurethane), “Sancure 2255” (polyester-polyurethane), “Sancure 815” (polyester-polyurethane), “Sancure 878” (polyether-polyurethane) and “Sancure 861” (polyether-polyurethane) by the company Sanncor, under the names “Neorez R-974” (polyester-polyurethane), “Neorez R-981” (polyester-polyurethane) and “Neorez R-970” (polyether-polyurethane) by the company ICI, and the acrylic copolymer dispersion sold under the name “Neocryl XK-90” by the company Avecia.

In one embodiment, the binder may be an aliphatic urethane acrylate. These materials are oligomers, such as Ebecryl® 8806, having an average molecular weight of about 2,000 and a viscosity of about 10,500 centipoise, at 156.degree. F. and manufactured and sold by Radcure Specialties, Inc. and Photomer® 6210 an aliphatic urethane acrylate oligomer having a molecular weight of about 1400, a viscosity of about 1500 centipoise at about 160° F. and manufactured and sold by Henkel Corporation.

In another embodiment, the binder is a polyacryl or polymethacryl resin. As used herein, a “polyacryl” includes polyacrylates, polyacrylics, or polyacrylamides, and “polymethacryl” includes polymethacrylates, polymethacrylics, or polymethacrylamides. These resins includes those derived from acrylic acid, acrylate esters, acrylamide, methacrylic acid, methacrylate esters, and methacrylamide. The acrylate and methacrylate ester generally contain from 1 to about 30 carbon atoms in the pendant group, or from 1 to about 18, or from 2 to about 12 carbon atoms in the pendant group.

Examples of commercial polyacryls and polymethacryls include Gelva® 2497 (commercially available from Monsanto Co., St. Louis, Mo.), Duraplus® 2 (commercially available from Rohm & Haas Co., Philadelphia, Pa.), Joncryl® 95 (commercially available from S. C. Johnson Polymer, Sturtevant, Wis.), SCX-1537 (S. C. Johnson Polymer), SCX-1959 (S. C. Johnson Polymer), SCX-1965 (S. C. Johnson Polymer), Joncryl® 530 (S. C. Johnson Polymer), Joncryl® 537 (S. C. Johnson Polymer), Glascol LS20 (commercially available from Allied Colloids, Suffolk, Va.), Glascol C37 (Allied Colloids), Glascol LS26 (Allied Colloids), Glascol LS24 (Allied Colloids), Glascol LE45 (Allied Colloids), Carboset® CR760 (commercially available from BFGoodrich, Cleveland, Ohio), Carboset® CR761 (BFGoodrich), Carboset® CR763 (BFGoodrich), Carboset® 765 (BFGoodrich), Carboset® 19X2 (B1FGoodrich), Carboset® XL28 (BFGoodrich), Hycar 26084 (BFGoodrich), Hycar 26091 (BFGoodrich), Carbobond 26373 (BFGoodrich), Neocryl® A-601 (commercially available from Avecia Resins, Wilmington, Mass.)Neocryl® A-612 (Avecia Resins), Neocryl® A-6044 (Avecia Resins), Neocryl® A-622 (Avecia Resins), Neocryl® A-623 (Avecia Resins), Neocryl® A-634 (Avecia Resins), and Neocryl® A-640 (Avecia Resins).

In another embodiment, the binder is a thermoplastic copolymer or terpolymer derived from ethylene or propylene and a functional monomer selected from the group consisting of alkyl acrylate, acrylic acid, alkyl acrylic acid, and combinations of two or more thereof. In one embodiment, the functional monomer is selected from alkyl acrylate, acrylic acid, alkyl acrylic acid, and combinations of two ore more thereof. In one embodiment, the binder is characterized by the absence of ethylene vinyl actetate resins, and acid or acid/acrylate-modified ethylene vinyl acetate resins. The alkyl groups in the alkyl acrylates and the alkyl acrylic acids typically contain 1 to about 8 carbon atoms, and, in one embodiment, 1 to about 2 carbon atoms. The functional monomer(s) component of the copolymer or terpolymer ranges from about 1 to about 15 mole percent, and, in one embodiment, about 1 to about 10 mole percent of the copolymer or terpolymer molecule. Examples include: ethylene/methyl acrylate copolymers; ethylene/ethylacrylate copolymers; ethylene/butyl acrylate copolymers; ethylene/methacrylic acid copolymers; ethylene/acrylic acid copolymers; anhydride-modified low density polyethylenes; anhydride-modified linear low density polyethylene, and mixtures of two or more thereof.

Ethylene acid copolymers are available from DuPont under the tradename Nucrel can also be used. These include Nucrel 0407, which has a methacrylic acid content of 4% by weight and a melting point of 109° C., and Nucrel 0910, which has a methacrylic acid content of 8.7% by weight and a melting point of 100° C. The ethylene/acrylic acid copolymers available from Dow Chemical under the tradename Primacor are also useful. These include Primacor 1430, which has an acrylic acid monomer content of 9.5% by weight, a melting point of about 97□C and a T_{g} of about −7.7° C. The ethylene/methyl acrylate copolymers available from Chevron under the tradename EMAC can be used. These include EMAC 2205, which has a methyl acrylate content of 20% by weight and a melting point of 83□C, and EMAC 2268, which has a methyl acrylate content of 24% by weight, a melting point of about 74° C. and a T_{g} of about −40.6° C.

In one embodiment, the binder is an ionomers (polyolefins containing ionic bonding of molecular chains) also are useful ionomer resins available from DuPont under the tradename Surlyn can also be used. These are identified as being derived from sodium, lithium or zinc and copolymers of ethylene and methacrylic acid. These include Surlyn 1601, which is a sodium containing ionomer having a melting point of 98° C., Surlyn 1605, which is a sodium containing ionomer having a melting point of about 90° C. and a T_{g} of about −20.6° C., Surlyn 1650, which is a zinc containing ionomer having a melting point of 97° C., Surlyn 1652 which is a zinc containing ionomer having a melting point of 100° C., Surlyn 1702, which is a zinc containing ionomer having a melting point of 93° C., Surlyn 1705-1, which is a zinc containing ionomer having a melting point of 95° C., Surlyn 1707, which is a sodium containing ionomer having a melting point of 92° C., Surlyn 1802, which is a sodium containing ionomer having a melting point of 99° C., Surlyn 1855, which is a zinc containing ionomer having a melting point of 88° C., Surlyn 1857, which is a zinc containing ionomer having a melting point of 87° C., and Surlyn 1901, which is a sodium containing ionomer having a melting point of 95° C.

In one embodiment, the binder is a combination of a polyurethane and a polyacryl. In this embodiment, the polyurethane is typically present in an amount of about 10% to about 90%, or from about 20% to about 80%, or from about 30% to about 70% of the solids of the coating composition. The polyacryl is typically present in an amount of about 10% to about 90%, or from about 20% to about 80%, or from about 30% to about 70% of the solids of the coating composition. The ratio of the polyurethane to the polyacryl is from about 0.1 to about 9, or from about 0.25 to about 4, or from about 0.4 to about 2.5 to 1.

In another embodiment, the binder is a polyester. The polyester may be one or more of those disclosed for preparing the above polyurethanes. In another embodiment, polyesters are prepared from various glycols or polyols and one or more aliphatic or aromatic carboxylic acids also are useful film materials. Polyethylene terephthalate (PET) and PETG (PET modified with cyclohexanedimethanol) are useful film forming materials which are available from a variety of commercial sources including Eastman. For example, Kodar 6763 is a PETG available from Eastman Chemical. Another useful polyester from duPont is Selar PT-8307 which is polyethylene terephthalate.

In another embodiment, the binder is a polyamide. Useful polyamide resins include resins available from EMS American Grilon Inc., Sumter, S.C. under the general tradename Grivory such as CF6S, CR-9, XE3303 and G-21. Grivory G-21 is an amorphous nylon copolymer having a glass transition temperature of 125° C., a melt flow index (DIN 53735) of 90 ml/10 min and an elongation at break (ASTM D638) of 15. Grivory CF65 is a nylon 6/12 film grade resin having a melting point of 135° C., a melt flow index of 50 ml/10 min, and an elongation at break in excess of 350%. Grilon CR9 is another nylon 6/12 film grade resin having a melting point of 200° C., a melt flow index of 200 ml/10 min, and an elongation at break at 250%. Grilon XE 3303 is a nylon 6.6/6.10 film grade resin having a melting point of 200° C., a melt flow index of 60 ml/10 min, and an elongation at break of 100%. Other useful polyamide resins include those commercially available from, for example, Union Camp of Wayne, New Jersey under the Uni-Rez product line, and dimer-based polyamide resins available from Bostik, Emery, Fuller, Henkel (under the Versamid product line). Other suitable polyamides include those produced by condensing dimerized vegetable acids with hexamethylene diamine. Examples of polyamides available from Union Camp include Uni-Rez 2665; Uni-Rez 2620; Uni-Rez 2623; and Uni-Rez 2695.

In another embodiment, the binder is a polyolefin. The polyolefins which include polymers and copolymers of ethylene, propylene, 1-butene, etc., or blends of mixtures of such polymers and copolymers. The polyolefins comprise homopolymers and copolymers of ethylene and propylene. In one embodiment, the polyolefins comprise propylene homopolymers, and copolymers such as propylene-ethylene and propylene-1-butene copolymers. In another embodiment, the polyolefins are those with a very high propylenic content, either polypropylene homopolymer or propylene-ethylene copolymers or blends of polypropylene and polyethylene with low ethylene content, or propylene-1-butene copolymers or blend of polypropylene and poly-1-butene with low butene content. Various polyethylenes can be utilized as the polymeric film material including low, medium, and high density polyethylenes. An example of a useful low density polyethylene (LDPE) is Rexene 1017 available from Huntsman. A number of useful propylene homopolymers are available commercially from a variety of sources, and some useful polymers include: 5A97, available from Union Carbide and having a melt flow of 12.0 g/10 min and a density of 0.90 g/cm³; DX5E66, also available from Union Carbide and having an MFI of 8.8 g/10 min and a density of 0.90 g/cm³; and WRD5-1057 from Union Carbide having an MFI of 3.9 g/10 min and a density of 0.90 g/cm³. Useful commercial propylene homopolymers are also available from Fina and Montel.

A variety of propylene copolymers are available and useful in the invention. The propylene copolymers generally comprise copolymers of propylene and up to 10% or even 20% by weight of at least one other alpha olefin such as ethylene, 1-butene, 1-pentene, etc. In one preferred embodiment, the propylene copolymers are propylene-ethylene copolymers with ethylenic contents with from about 0.2% to about 10% by weight. Such copolymers are prepared by techniques well known to those skilled in the art, and these copolymers are available commercially from, for example, Union Carbide. A propylene-ethylene copolymer containing about 3.2% by weight of ethylene is available from Union Carbide under the designation D56D20. Another Union Carbide propylene-ethylene copolymer is D56D8, which contains 5.5% by weight of ethylene.

In another embodiment, the binder is a cellulosic polymer. The cellulosic polymers include polymers derived from cellulose such as are known in the art. An example of a cellulosic polymer includes cellulose esters. Useful cellulosic polymers include carboxyethyl cellulose, dextrin, methyl cellulose, ethyl cellulose, hydroxyethyl cellulose, hydroxypropylcellulose, hydroxypropylmethyl cellulose nitrocellulose, cellulose acetate, cellulose acetate butyrate, and cellulose acetate propionate. Exemplary nitrocellulose polymers are nitrocellulose RS types (nitrogen content of 11.5-12.2%) of Hercules, such as nitrocellulose-RS ½ second, -RS ¼ second, -RS ⅛ second, -RS 1/16 second or the like.

In one embodiment, the binder is a protein. Examples of the proteins include gelatin, casein, and soybean protein. is In another embodiment, the binder is a rubber. These rubbers include synthetic rubbers, such as isoprene rubbers, neoprene rubbers, polydiene polymers such as styrene-butadiene copolymers, styrene-acrylonitrile-butadiene terpolymers,styrene-isoprene copolymers, polybutadiene, polyalkenes, such as polybutene, polyisobutylene, polypropylene and polyethylene. The rubber based elastomers, such as linear, branched, grafted, or radial block copolymers represented by the diblock structures A-B, the triblock A-B-A, the radial or coupled structures (A-B)ₙ, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may comprise from about 75% to about 95% by weight of rubbery segments and from about 5% to about 25% by weight of non-rubbery segments.

The non-rubbery segments or hard blocks comprise polymers of mono-and polycyclic aromatic hydrocarbons, and more particularly vinyl-substituted aromatic hydrocarbons which may be monocyclic or bicyclic in nature. The rubbery blocks or segments are polymer blocks of homopolymers or copolymers of aliphatic conjugated dienes. Rubbery materials such as polyisoprene, polybutadiene, and styrene butadiene rubbers may be used to form the rubbery block or segment. Particularly useful rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes which may be utilized include any of those which exhibit elastomeric properties. The block copolymers may be diblock, triblock, multiblock, starblock, polyblock or graftblock copolymers. Throughout this specification and claims, the terms diblock, triblock, multiblock, polyblock, and graft or grafted-block with respect to the structural features of block copolymers are to be given their normal meaning as defined in the literature such as in the Encyclopedia of Polymer Science and Engineering, Vol. 2, (1985) John Wiley & Sons, Inc., New York, pp. 325-326, and by J. E. McGrath in Block Copolymers, Science Technology, Dale J. Meier, Ed., Harwood Academic Publishers, 1979, at pages 1-5.

The block copolymers may be prepared by any of the well-known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356, the disclosures of which are hereby incorporated by reference.

Conjugated dienes which may be utilized to prepare the polymers and copolymers are those containing from 4 to about 10 carbon atoms and more generally, from 4 to 6 carbon atoms. Examples include from 1,3-butadiene, 2-methyl-1,3-butadiene (isoprene), 2,3-dimethyl-1,3-butadiene, chloroprene, 1,3-pentadiene, 1,3-hexadiene, etc. Mixtures of these conjugated dienes also may be used. Useful conjugated dienes are isoprene and 1,3-butadiene.

Examples of vinyl aromatic hydrocarbons which may be utilized to prepare the copolymers include styrene and the various substituted styrenes such as o-methylstyrene, p-methylstyrene, p-tert-butylstyrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro-4-methylstyrene, etc. The preferred vinyl aromatic hydrocarbon is styrene.

Specific examples of diblock copolymers include styrene-butadiene (SB), styrene-isoprene (SI), and the hydrogenated derivatives thereof. Examples of triblock polymers include styrene-butadiene-styrene (SBS), styrene-isoprene-styrene (SIS), alpha-methylstyrene-butadiene-alpha-methylstyrene, and alpha-methylstyrene-isoprene alpha-methylstyrene. Examples of commercially available block copolymers include those available from Shell Chemical Company.

Upon hydrogenation of the SBS copolymers comprising a rubbery segment of a mixture of 1,4 and 1,2 isomers, a styrene-ethylene-butylene styrene (SEBS) block copolymer is obtained. Similarly, hydrogenation of an SIS polymer yields a styrene-ethylene propylene-styrene (SEPS) block copolymer.

The selective hydrogenation of the block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Particularly useful hydrogenated block copolymers are hydrogenated products of the block copolymers of styrene-isoprene-styrene such as a styrene-(ethylene/propylene)-styrene block polymer. A number of selectively hydrogenated block copolymers are available commercially from Shell Chemical Company under the general trade designation “Kraton G.” One example is Kraton G1652 which is a hydrogenated SBS triblock comprising about 30% by weight of styrene end blocks and a midblock which is a copolymer of ethylene and 1-butene (EB). A lower molecular weight version of G1652 is available from Shell under the designation Kraton G1650. Kraton G1651 is another SEBS block copolymer which contains about 33% by weight of styrene. Kraton G1657 is an SEBS diblock copolymer which contains about 13% w styrene. This styrene content is lower than the styrene content in Kraton G1650 and Kraton G1652.

In anther embodiment, the block copolymers may also include functionalized polymers such as may be obtained by reacting an alpha, beta-olefinically unsaturated monocarboxylic or dicarboxylic acid reagent onto selectively hydrogenated block copolymers of vinyl aromatic hydrocarbons and conjugated dienes as described above. The preparation of various selectively hydrogenated block copolymers of conjugated dienes and vinyl aromatic hydrocarbons which have been grafted with a carboxylic acid reagent is described in a number of patents including U.S. Pat. Nos. 4,578,429; 4,657,970; and 4,795,782, and the disclosures of these patents relating to grafted selectively hydrogenated block copolymers of conjugated dienes and vinyl aromatic compounds, and the preparation of such compounds are hereby incorporated by reference. U.S. Pat. No. 4,795,782 describes and gives examples of the preparation of the grafted block copolymers by the solution process and the melt process. U.S. Pat. No. 4,578,429 contains an example of grafting of Kraton G1652 (SEBS) polymer with maleic anhydride with 2,5-dimethyl-2,5-di(t-butylperoxy) hexane by a melt reaction in a twin screw extruder. (See Col. 8, lines 40-61.)

Examples of commercially available maieated selectively hydrogenated copolymers of styrene and butadiene include Kraton FG1901X, FG1921X, and FG1924X from Shell, often referred to as maleated selectively hydrogenated SEBS copolymers. FG1901X contains about 1.7% w bound functionality as succinic anhydride and about 28% w of styrene. FG1921X contains about 1% w of bound functionality as succinic anhydride and 29% w of styrene. FG1924X contains about 13% styrene and about 1% bound functionality as succinic anhydride.

Useful block copolymers also are available from Nippon Zeon Co., 2-1, Marunochi, Chiyoda-ku, Tokyo, Japan. For example, Quintac 3530 is available from Nippon Zeon and is believed to be a linear styrene-isoprene-styrene block copolymer.

In another embodiment, the binder is an ethylene alpha-olefin copolymers. These copolymers include ethylene-propylene or ethylene-propylene-diene copolymers. In either event, the average ethylene content of the copolymer could be as low as about 20% and as high as 90% to 95% on a weight basis. The remainder is either propylene or diene. In a preferred embodiment, the copolymers will contain from about 50% or 60% by weight up to about 80% by weight of ethylene.

The ethylene, alpha-olefin copolymers are available commercially from a variety of sources. For example, a variety of ethylene/propylene copolymers are available from Polysar Corp. (Bayer) under the general trade designation “POLYSAR.” Particular examples include POLYSAR EPM 306 which is an ethylene/propylene copolymer containing 68 weight percent ethylene and 32 weight percent propylene; POLYSAR EPDM 227 is a copolymer of ethylene, propylene and 3% ENB wherein the ethylene/propylene ratio is 75/25. An example of a copolymer containing a smaller amount of ethylene is POLYSAR EPDM 345 which contains 4% ENB and the weight ratio of ethylene/propylene is 60/40. Bayer XF-004 is an experimental EPDM containing 65 weight percent of ethylene, 32% by weight of propylene and 3% by weight of norbormenediene (NB). Another group of ethylene/propylene rubbers are available from Bayer under the general trade designation “BUNA AP.” In particular, BUNA AP301 is an ethylene/propylene copolymer containing 51% ethylene and 49% propylene; BUNA AP147 is a copolymer containing 4% ENB and the weight ratio of ethylene/propylene is 73/27.

Ethylene/propylene rubbers are also available from Exxon Chemical Company. One example is VISTALON 719 which has a typical ethylene content of 75%, a typical Mooney viscosity (at 127° C.) of 54, and a specific gravity of 0.87.

In another embodiment, the binder is a homopolymer or copolymer of vinyl acetate. Examples of these polymers include polyvinyl acetate, polyethylene vinyl acetate, acrylic acid or acrylate-modified ethylene vinyl acetate resins, acid-, anhydride- or acrylate-modified ethylene/vinyl acetate copolymers; acid- or anhydride-modified ethylene/acrylate copolymers. Examples of commercially to available copolymers and terpolymers that can be used include the ethylene/vinyl acetate copolymers available from DuPont under the tradename Elvax. Other examples of commercially available EVA resins are available from Air Products & Chemicals, Inc., Allentown, Pa., under the AIRFLEX trademark.

Examples include AIRFLEX 465® (65% solids) and AIRFLEX 7200® (72-74% solids). Another suitable EVA emulsion polymer is AIRFLEX 426®, a high solids, carboxylated, EVA polymer partially functionalized with carboxyl groups. It is believed that the AIRFLEX brand EVA emulsion polymers are stabilized with up to about 5% by weight polyvinyl alcohol (PVOH) and/or, in some formulations, a nonionic surfactant.

Examples of commercially available copolymers and terpolymers that can be used include the ethylene/vinyl acetate copolymers available from DuPont under the tradename Elvax. These include Elvax 3120, which has a vinyl acetate content of 7.5% by weight and a melting point of 99° C., Elvax 3124, which has a vinyl acetate content of 9% by weight and a melting point of 77° C., Elvax 3150, which has a vinyl acetate content of 15% by weight and a melting point of 92° C., Elvax 3174, which has a vinyl acetate content of 18% by weight and a melting point of 86° C., Elvax 3177, which has a vinyl acetate content of 20% by weight and a melting point of 85° C., Elvax 3190, which has a vinyl acetate content of 25% by weight and melting point of 77° C., Elvax 3175, which has a vinyl acetate content of 28% by weight and a melting point of 73° C., Elvax 3180, which has a vinyl acetate content of 28% by weight and a melting point of 70° C., Elvax 3182, which has a vinyl acetate content of 28% by weight and a melting point of 73° C., and Elvax 3185, which has a vinyl acetate content of 33% by weight and a melting point of 61° C., and Elvax 3190LG, which has a vinyl acetate content of 25% by weight, a melting point of about 77° C. and a glass transition temperature (T_{g}) of about −38.6° C. Commercial examples of available polymers include Escorene UL-7520, a copolymer of ethylene with 19.3% vinyl acetate (Exxon).

In one embodiment, the binder is a polystyrene. Polystyrenes include homopolymers as well as copolymers of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA); etc. An example of a useful styrene copolymer is KR-10 from Phillip Petroleum Co. KR-10 is believed to be a copolymer of styrene with 1,3-butadiene. Another useful polystyrene is a copolymer of styrene and an alkyl acrylate in which the alkyl moiety has 1 to 6 carbon atoms. Butyl acrylate is especially useful as the comonomer of styrene. One particular commercially available source of the copolymer is the styrene/butyl acrylate copolymer dispersion available under the Trade-mark ACRONAL S312D, S320D and S305D from BASF.

In one embodiment, the binder is a styrene-acryl copolymer. The acryl component is describe above. In one embodiment, the acryl may be an acrylic acid or ester, an acrylonitrile or their methacrylic analogs. Examples of the these resins include Microgel E-1002, E-2002, E-5002 (styrene acryl resin emulsion, available from Nippon Paint Co., Ltd.), Voncoat 4001 (acryl emulsion, available from Dainippon Ink & Chemicals, Inc.), Voncoat 5454 (styrene acryl resin emulsion, available from Dainippon Ink & Chemicals, Inc.), SAE 1014 (styrene acryl resin emulsion, available from Nippon Zeon Co., Ltd.), Saivinol SK-200 (acryl resin emulsion, available from Saiden Chemical Industry Co., Ltd.), Nanocryl SBCX-2821 (silicone-modified acryl resin emulsion, available from Toyo Ink Mfg. Co., Ltd.), Nanocryl SBCX-3689 (silicone-modified acryl resin emulsion, available from Toyo Ink Mfg. Co., Ltd.), #3070 (methacrylic acid methyl polymer resin emulsion, available from Mikuni Color Limited), SG-60 (styrene-acryl resin emulsion, available from Gifu Ceramic Co., Ltd.), and Grandol PP-1000 (Styrene-acryl resin emulsion, available from Dainippon Ink & Chemicals, Inc.).

In another embodiment, the binder is a polyvinylchloride resin (sometimes referred to herein as PVC resins). These resins are well known and are either homopolymers of vinyl chloride or copolymers of vinyl chloride with a minor amount by weight of one or more ethylenically-unsaturated comonomers which are copolymerizable with the vinyl chloride. Examples of these ethylenically-unsaturated comonomers include vinyl halides, such as vinyl fluoride and vinyl bromide; alpha-olefins, such as ethylene, propylene and butylene; vinyl esters, such as vinyl acetate, vinyl propionate, vinyl butyrate and vinyl hexanoate, or partially hydrolyzed products thereof, such as vinyl alcohol; vinyl ethers, such as methyl vinyl ether, propyl vinyl ether and butyl vinyl ether; acrylic esters, such as methyl acrylate, ethyl acrylate, methyl methacrylate and butyl methacrylate and other monomers, such as acrylonitrile, vinylidene chloride and dibutyl maleate. Such resins are generally known any many are commercially available. A particularly useful polyvinylchloride resin is the homopolymer of vinyl chloride.

Examples of polyvinylchloride resins that are commercially available include GEON® 92, a medium high molecular weight porous suspension PVC resin; GEON® 128, a high molecular weight dispersion grade polyvinylchloride resin; and GEON® 11X 426FG, a medium molecular weight PVC resin. The GEON® resins are available from the Geon Company. The number average molecular weights of the PVC resins useful in the present invention may range from about 20,000 up to about 80,000, and a typical range of about 40,000 to about 60,000.

Fillers

The topcoat composition also includes a filler. Typically the filler are those that have a surface area of at least 1 M²/g. In another embodiment, the surface area of the filler is greater than 5, or greater than 10, or greater than 20 M²/g. In another embodiment, the fillers are those having a surface area of greater than 200 m²/g. The surface area of the filler is determined by BET (Brunauer, Emmett and Teller method described in J. American Chemical Society Vol. 60, page 309 (1938). This method is based on the adsorption of gaseous nitrogen.

Examples of fillers include silica, such as amorphous silica, fumed silica, colloidal silica, precipitated silica and silica gels. Additional fillers include a silica, a clay, an alkaline earth metal sulfate or carbonate, an alkaline earth or transition metal oxide or hydroxide. In one embodiment, the filler is a silica having a surface area of at least about 40, or at least 60, or at least about 100 m²/g. In another embodiment, the filler is a silica with a surface area of at least 150, or at least about 200, or at least about 250 m²/g.

The filler is typically present in a minor amount. In one embodiment, the filler is present in an amount from about 5% up to about 49%, or from about 10% up to about 40%, or from about 15% to about 35%. In another embodiment, the filler is present in an amount greater than 20%, or greater than 30% and up to about 50%, or 45%. In one embodiment, the filler to binder ratio is at least 0.01 to about 2, or from about 0.3 to about 1.5 or from about 0.5 to about 1.

The following table contains filler, which may be used in the coating compositions.

FILLERS

| | | | Surface | Particle |
|---|---|---|---|---|
| | | | Area | size |
| Supplier | Code | Filler Type | sqm/g | micron |
| Degussa | Sipernat 570 | precipitated silica | 750 | 6.7 |
| Grace | Syloid W500 | silica gel | 270 | 8 |
| Grace | Sylojet 710A | silica gel | 235 | 1 |
| | Sipernat 383 | | | |
| Degussa | DS | precipitated silica | 170 | 5 |
| Degussa | Sipernat 350 | precipitated silica | 50 | 3 |
| | China Clay | | | |
| Imerys | Supreme | SiO2-AI2O3Kaolin | 16 | 1 |
| Imerys | Carbital 110 | calcium carbonate | 5 | <10 |
| Viaton | Airwhite | | | |
| Industries Ltd | AW5 | barium sulphate | 1.2 | 2 |

The topcoat compositions are applied to any substrate to make an ink receptive sheet. The materials useful as the substrate layer and as the layer or layers in contact with the topcoat include cellulose based substrates such as paper, film based substrates, such as polyolefin films, polyester films, polyamide films and polyurethane films, and cellulose based substrates that have been coated with film forming materials derived from polyolefins, polyesters, polyamides and polyurethanes. A sample of substrates which may be used includes paper stocks as well as film stocks such as Fasclear, Primax, Mirage and Graphics XL cast vinyl, MX calendared vinyl many of which are available from Avery Dennison Corporation.

Other additives can be added as well to obtain a certain desired characteristic, such as waxes, defoamers, surfactants, colourants, anti-oxidants, UV stabilizers, luminescents, cross-linkers etc.

In one embodiment, the coating composition includes a wax. The wax is typically present in an amount from about 0.5% to about 10%, or from about 1% to about 5% of the solids of the coating composition. The wax helps improve scratch resistance. In one embodiment, the particles in the wax are less than 5, or less than 0.5 microns in size. The melting point of the wax or of the mixture of waxes preferably ranges from 50-150° C. In addition, the particles in the microdispersion can contain a small amount of oily or pasty fatty additives, one or more surfactants and one or more common liposoluble active ingredients,

The waxes include natural (animal or plant) or synthetic substances which are solid at room temperature (20-25° C.). In one embodiment, they are insoluble in water, soluble in oils and are capable of forming a water-repellent film. A definition of waxes is provided by, for example, P. D. Dorgan, Drug and Cosmetic Industry, December 1983, pp. 30-33. The wax(es) includes carnauba wax, candelilla wax and alfalfa wax, and mixtures thereof.

In addition to these waxes, the mixture of waxes can also contain one or more of the following waxes or family of waxes: paraffin wax, ozokerite, plant waxes, such as olive wax, rice wax, hydrogenated jojoba wax or the absolute waxes of flowers, such as the essential wax of blackcurrant flower sold by the company Bertin (France), animal waxes, such as beeswaxes or modified beeswaxes (cerabellina); other waxes or waxy starting materials; marine waxes, such as those sold by the company Sophim under the identifier M82; natural or synthetic ceramides, and polyethylene or polyolefin waxes in general. The carnauba (extract of Copernica cerifera), candelilla (extract of Euphorbia cerifera and of Pedilantus pavonis) and alfalfa (extract of Stipa tenacissima) plant waxes are commercial products. Examples of commercially available waxes are Aquacer 499, 520, 537, 608 available from Byk Cera.

In another embodiment, the coating composition includes a cross linking agent. Generally, the cross linking agent is present in an amount from about 0.01% to about 20%, or from about 0.3% to about 1.5%, or from about 0.5% to about 1% by weight of the solids of the coating composition. The cross linking agent may be any of those know to those in the art. The cross linking agents may be organic or inorganic. A combination of cross linking agents may be used. The cross linking agents include such as epoxy compounds, polyfunctional aziridines, methoxyalkyl melamines, triazines, polyisocyanates, carbodiimides, polyvalent metal cations, and the like. The cross linking agent supplied by Avecia Resins under the tradename NeoCryl CX 100 and the cross linking agent supplied by EIT Industries under the tradename XAMA-7 are specific examples of polyfunctional aziridine cross linking agents and the cross linking agent supplied by Union Carbide under the tradename Ucarlink XL-29SE is a specific example of a polyfunctional carbodimide cross linking agent which may be used. In another embodiment, the cross linking agent is a metal containing crosslinking agent. The cross linking agents include the organometallic catalysts containing metals of group III-A, IV-A, V-A, VI-A, VIII-A, I-B, II-B, III-B, IV-B and V-B. Particularly useful cross linking agents are tin dioctoate, tin naphthenate, dibutyltin dilaurate, dibutyltin diacetate, dibutyltin dioxide, dibutyl tin dioctoate, zirconium chelates, aluminum chelates, aluminum titanates, titanium isopropoxide, triethylene diamine, p-toluene sulfonic acid, n-butyl phosphoric acid, and mixtures thereof. An example of a Zirconium based cross-linker is Bacote 20 from Magnesium Electron Ltd

In one embodiment, the coating compositions optionally contain water or a other suitable diluent such as alcohol, toluene, heptane, methylethylketone, ethylacetate etc. The diluent is typically present in an amount from about 10% to about 90%, or from about 20% to about 80% by weight.

The topcoat is coated onto the substrate. It should be noted these substrates may be individual paper or film face stocks or may also be multilayer constructions. The multilayer constructions may be coextruded or laminated articles which are useful for printing applications. These articles include those that have adhesive layers. These articles are useful as label and graphic stocks.

The topcoat can be coated onto substrates in various manners, for instance by means of engraving coating, off-set coating, a casting process or by (co)extrusion. The choice for a certain production method depends strongly on the raw material characteristics and on the desired thickness of the coating.

Drying of a water or diluent based system can be done by the usual thermal drying techniques, by means of microwaves or infrared drying. Solventless systems can be cured thermally, by means of UV curing or Electron Beam curing.

The coating is typically applied in the following manner. A coating composition, which is a solution, dispersion or emulsion containing one (or more) binder(s) and one or more fillers is applied to a film or paper by means of techniques known in the industry. In a ventilated oven, the diluentor water is evaporated, after which a top layer with the desired thickness is obtained. If desired one or more layers between the film or paper and the coating can be provided. These may serve to obtain certain desired additional characteristics, such as a desired color, opacity etc.

When the composite film or paper according to the invention has to be used as a label, the film or paper can be provided with an adhesive layer at the side that is not covered with the topcoat. This adhesive layer may consist of a pressure sensitive adhesive or a heat activated adhesive. All adhesives can be used. Additionally the film or paper can be used without an adhesive layer, being the case in inmold-labelling. A primer coating may be used to improve adhesive to between the substatrate and the topcoat.

The topcoat can be coated onto substrates in various manners, for instance by means of engraving coating, off-set coating, a casting process or by (co)extrusion. The choice for a certain production method depends on the raw material characteristics and on the desired thickness of the coating. Drying of a water or diluent based system can be done by the usual thermal drying techniques, by means of microwaves or infrared drying. Solventless systems can be cured thermally, by means of UV curing or Electron Beam curing.

The following examples relate to coating compositions and their preparation. These examples are illustrative and not intended to be limiting in scope. Unless otherwise indicated, the temperature is ambient temperature, the pressure is atmospheric pressure, amounts are by weight and the temperature is in degrees Celsius.

### EXAMPLE 1

A reaction vessel is charged with 100 parts of water. Then, 45 parts of silicon dioxide (Sipernat 570) is added to the vessel with stirring. Thereafter, 55 parts of an acrylic emulsion comprising 69% butyl acrylate, 26% methyl methacrylate and 5% methacrylic acid is added with stirring. The mixture is stirred for an additional three minutes to yield a coating composition having 20% solids.

### EXAMPLE 2-10

The following table contain further examples of coating compositions. These coating compositions are prepared as described in Example 1.

| | 2 | 3 | 4 | 5 | 6 | 7 | 8 | 9 | 10 |
|---|---|---|---|---|---|---|---|---|---|
| Binders | | | | | | | | | |
| Sancure 2710 | 163 | — | — | 63 | — | — | 75 | — | — |
| (40% solids) | | | | | | | | | |
| Neocryl XK-90 | — | — | — | — | — | 156 | — | 70 | — |
| (45% solids) | | | | | | | | | |
| Joncryl 95 | — | — | — | — | 116 | — | — | — | 90 |
| (30% solids) | | | | | | | | | |
| Airflex 465 | — | 85 | — | — | — | — | 35 | — | — |
| (65% solids) | | | | | | | | | |
| Hydroxyethyl | — | — | 250 | — | 67 | — | 30 | — | — |
| cellulose | | | | | | | | | |
| (30% solids) | | | | | | | | | |
| NeoRez-600 | — | — | — | 91 | — | — | — | 64 | 112 |
| (33% solids) | | | | | | | | | |
| Fillers | | | | | | | | | |
| Sipernat 570 | 35 | — | — | 43 | — | 30 | — | — | 35 |
| (100% solids) | | | | | | | | | |
| Sylojet 710A | — | 125 | 125 | — | 220 | — | — | 225 | — |
| (20% solids) | | | | | | | | | |
| Carbital 110 | — | 20 | — | — | — | — | — | — | — |
| (100% solids) | | | | | | | | | |
| Aquacer 570 | — | — | — | 7 | — | — | 7 | 6 | — |
| (30% solids) | | | | | | | | | |
| CX-100 (100% solids) | — | — | — | — | 1.1 | — | 1 | 0.7 | 1 |
| Water | 202 | 70 | 25 | 99 | — | 117 | 217 | 34 | 62 |
| % solids | 25% | 33% | 25% | 33% | 25% | 33% | 25% | 25% | 33% |

The following examples relate to coating compositions and testing performed to show the improved print quaility of the present invention.

1) Preparation of Topcoat Mixtures

The topcoat mixtures with filler and binder in different ratios are made according to the following procedure. A jar with the desired quantity of de-ionized water is put under a stirrer. After starting of the stirrer (300 rpm, propeller stirrer) the desired quantity of filler is added under mixing. After 2 minutes of mixing the desired quantity of the binder emulsion is added under mixing. Hereafter the jar is mixed for another 3 minutes. Total quantity of a mixture: 100 g; % solids 20%. Filler/binder (solid/solid ratios) are made of: 0.0/1.0, 0.3/1.0, 0.6/1.0, 1.0/1.0, 2.0/1.0.

The topcoat mixtures without fillers, are made according to the following procedure. A jar with the desired quantity of binder is put under a stirrer. Under stirring (300 rpm; propeller stirrer) de-ionized water is added to reduce the solid % to 20%. Total quantity of a mixture: 100 g. The original % solids of Neocryl XK-90 is 45% and the original solids for Sancure 2710 is 40%.

2) Preparation of Lab Spreads

The topcoat is produced as follows. The topcoats are applied on a film or paper by means of a Meyer-bar. The film or paper with the wet topcoat is dried during 60 seconds at 80° C. in a ventilated oven. The coat-weight of the layer is 3.5 g/m² after drying.

3) Printing

Printing of the topcoated samples is carried out with Xaarjet 500-360 printheads (Resolution 360 dpi). Used inks:

Ink Composition

| Xaarjet XUV Black | |
|---|---|
| Acrylate esters | 20-30% |
| Isobornyl acrylate | 20-50% |
| Tripropylene glycol diacrylate | 15-30% |
| 2-methyl-1-(4methylthiophenyl)-2-morpholinopropan-1-one | ˜5% |
| Xaarjet XUV Cyan/Magenta/Yellow | |
| Acrylate esters | 20-30% |
| Diphenyl(2,4,6-trimethylbenzoyl)phosphine oxide | ˜5% |
| 2-hydroxy-2-methylpropiophenone | ˜5% |
| Isobornyl acrylate | 20-50% |
| Tripropylene glycol diacrylate | 15-30% |
| Polymer acid salt/Polymer amide | <5% |

| | |
|---|---|
| Printing speed: | 20 m/min |
| Curing information: | |
| UV-lamp: | Fe doped medium pressure Mercury |
| | lamp; 200 W/cm (For example D- |
| | type bulb from Fusion) |

4) Assessment of the Print Quality

To test the performance of the topcoats, solid squares are printed of a size of 11×11 mm having one square per color. The print quality is judged upon the presence of mottling. Mottling is defined as an uneven ink coverage. In particular this is visible in printed solid areas. Rating of quality is as follows:

1=very poor quality. Areas with severe uneven coverage clearly visible

2=poor quality. Areas with uneven coverage visible.

3=medium quality. Areas with some uneven coverage visible

4=acceptable quality. Defects in coverage only visible after careful checking

5=good quality. No defects in coverage.

Influence of Adding Filler to Binder on Mottling

TABLE 1

| | | Filler/Binder | | |
|---|---|---|---|---|
| | | Ratio | | |
| Filler | Binder | (s/s) | Substrate | Mottl |
| None | None | corona treated | PE-85 | 1 |
| | | PE | | |
| None | XK-90 | 0.0/1.0 | PE-85 | 1 |
| Sipernat 570 | XK-90 | 0.3/1.0 | PE-85 | 4 |
| Sipernat 570 | XK-90 | 0.6/1.0 | PE-85 | 4 |
| Sipernat 570 | XK-90 | 1.0/1.0 | PE-85 | 5 |
| Syloid W500 | XK-90 | 0.3/1.0 | PE-85 | 4 |
| Syloid W500 | XK-90 | 0.6/1.0 | PE-85 | 4 |
| Syloid W500 | XK-90 | 1.0/1.0 | PE-85 | 3 |
| Sylojet 710A | XK-90 | 0.3/1.0 | PE-85 | 2 |
| Sylojet 710A | XK-90 | 0.6/1.0 | PE-85 | 5 |
| Sylojet 710A | XK-90 | 1.0/1.0 | PE-85 | 5 |
| Sipernat 383 DS | XK-90 | 0.3/1.0 | PE-85 | 3 |
| Sipernat 383 DS | XK-90 | 0.6/1.0 | PE-85 | 2 |
| Sipernat 383 DS | XK-90 | 1.0/1.0 | PE-85 | 2 |
| Sipernat 350 | XK-90 | 0.3/1.0 | PE-85 | 2 |
| Sipernat 350 | XK-90 | 0.6/1.0 | PE-85 | 4 |
| Sipernat 350 | XK-90 | 1.0/1.0 | PE-85 | 2 |
| China Clay | XK-90 | 1.0/1.0 | PE-85 | 1 |
| Supreme | | | | |
| China Clay | XK-90 | 2.0/1.0 | PE-85 | 4 |
| Supreme | | | | |
| Carbital 110 | XK-90 | 1.0/1.0 | PE-85 | 2 |
| Carbital 110 | XK-90 | 2.0/1.0 | PE-85 | 1 |
| Airwhite AW5 | XK-90 | 1.0/1.0 | PE-85 | 1 |
| Airwhite AW5 | XK-90 | 2.0/1.0 | PE-85 | 1 |

TABLE 2
Other type or binder

| | | Filler/Binder | | |
|---|---|---|---|---|
| | | Ratio | | |
| Filler | Binder | (s/s) | Substrate | Mottl |
| None | Sancure 2710 | 0.0/1.0 | PE-85 | 1 |
| Sylojet 710A | Sancure 2710 | 0.6/1.0 | PE-85 | 5 |
| Sylojet 710A | Sancure 2710 | 0.6/1.0 | PE-85 | 2 |

TABLE 3
Other of type of substrates

| | | Filler/Binder | | |
|---|---|---|---|---|
| | | Ratio | | |
| Filler | Binder | (s/s) | Substrate | Mottle |
| None | None | 0.0/0.0 | PP-60 | 1 |
| None | XK-90 | 0.0/1.0 | PP-60 | 1 |
| Sylojet 710A | XK-90 | 0.3/1.0 | PP-60 | 3 |
| Sylojet 710A | XK-90 | 0.6/1.0 | PP-60 | 3 |
| Sylojet 710A | XK-90 | 1.0/1.0 | PP-60 | 2 |
| None | None | | High Gloss | 1 |
| | | | White Paper | |
| Sylojet 710A | XK-90 | 1.0/1.0 | High Gloss | 3 |
| | | | White Paper | |

Suppliers
BINDERS

| Supplier | Code | Binder Type |
|---|---|---|
| Avecia | Neocryl XK-90 | methacrylic emulsion |
| BF Goodrich | Sancure2710 | aliphatic polyester polyurethane dispersion |

SUBSTRATES for TOPCOATS

| | | Supplier code | Supplier |
|---|---|---|---|
| Film | White MDPE 85 micron film | KC5767.060 | Nordenia |
| | White PP 60 micron film | Rayoface 58 | UCB |
| Paper | High Gloss White | Sinarlux | APP |

Water Immersion Stability Tests

The water stability of printed samples are tested after 1 hour immersion in water of 40° C. With a tape test, the sample are assessed whether the coating+print performed well or not. An adhesive tape (Scotch 810 tape) is applied on the printed areas. After 5 seconds the tape is peeled off at a fast rate and at an angle of 30° in the machine direction. Hereafter the samples are checked whether the coating or the print has been peeled off. The tape test is performed with immersed and non-immersed samples. The immersed samples are dried with a cloth. After a few minutes of conditioning the tape test is conducted.

TABLE 4
WATER IMMERSION TESTS

| | | | | Tape Test | |
|---|---|---|---|---|---|
| | | Filler/Binder Ratio | | Non immersed | Immersed |
| Filler | Binder | (s/s) | Substrate | samples | samples |
| None | XK-90 | 0.0/1.0 | PE-85 | no transfer | no transfer |
| Sylojet 710A | XK-90 | 0.6/1.0 | PE-85 | no transfer | no transfer |
| Sylojet 710A | XK-90 | 1.0/1.0 | PE-85 | no transfer | no transfer |
| Reference Sample | | | | no transfer | split of topcoat |

Information About Used Reference Sample:

The sample used as reference, is a topcoated PP film from Oji that is commercially available for onventional ink-jet printing.

In this example the sample is printed with the UV curable ink-jet inks to show the difference in performance compared to the topcoat according to the invention.

| | |
|---|---|
| Supplier: | Oji |
| Code: | IJC-YCG |
| Composition: | |
| Topcoat: | |
| Filler | SiO2. TGA analyses indicate |
| | Filler/Binder = 1.4/1.0 |
| Binder | vinylacetate/acrylate copolymer |
| Weight | 20 g/sqm |
| Thickness of topcoat | 40 micron |
| Film | |
| PP with CaCO3 | TGA analyses indicate about 51% CaCO3 |
| Thickness of PP film | 80 micron |
| (without topcoat) | |

As can be seen from the above data, print quaility is improved when the binders and fillers of the present invention are used together in the coating composition.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A coating composition comprising a) at least one binder and b) at least one filler having a surface area of at least about 1 m²/g and wherein a topcoat derived from the coating composition is printable with a UV curable ink-jet ink.

2. The coating composition of claim 1 wherein the binder comprises at least one resin selected polyurethanes, polyacryls, polyesters, polyamides, polyvinyl alcohols, polyvinyl pyrrolidinones, polyvinylchloride, proteins, cellulosic polymers, vinyl acetate homopolymers and co- or terpolymers, and styrene acryl copolymers.

3. The coating composition of claim 1 wherein the binder is a combination of a polyurethane and an acrylate resin.

4. The coating composition of claim 1 wherein the binder is present in a major amount of solids of the coating composition.

5. The coating composition of claim 1 wherein the filler is inorganic.

6. The coating composition of claim 1 wherein the filler is a silica, a clay, an alkaline earth metal sulfate or carbonate, an alkaline earth or transition metal oxide or hydroxide.

7. The coating composition of claim 1 wherein the filler is present in a minor amount of the solids of the coating composition.

8. The coating composition of claim 1 further comprising at least one diluent.

9. The coating composition of claim 1 further comprising at least one wax.

10. A coating composition comprising a) at least one binder selected from a polyurethane, an acrylate resin, a polyester, or combination of two or more thereof, and b) at least one filler, wherein a topcoat derived from the coating composition is printable with a UV curable ink-jet ink.

11. The coating composition of claim 11 wherein the binder is present in a major amount of the solids of the coating composition.

12. The coating composition of claim 11 wherein the binder is a combination of a polyurethane and an acrylate resin.

13. The coating composition of claim 11 wherein the binder is present in a major amount of the solids of the coating composition.

14. The coating composition of claim 11 the filler has a surface area of at least about 1 m²/g.

15. The coating composition of claim 11 wherein the filler is selected from a silica, a clay, an alkaline earth metal sulfate or carbonate, an alkaline earth or transition metal oxide or hydroxide.

16. The coating composition of claim 11 wherein the filler is a silica.

17. An article with an ink receptive printing layer, comprising a substrate having a topcoat, wherein the topcoat is printable with UV curable ink-jet inks.

18. The article of claim 18 wherein the topcoat has a thickness from about 0.01 to about 20 g/m².

19. The article of claim 18 wherein substrate is a paper or film substrate.

20. The article of claim 18 wherein the binder comprises at least one resin selected from acrylates, polyurethanes, rubbers, polyvinyl alcohols and cellulosic resins.

21. The article of claim 18 wherein the binder is a combination of a polyurethane and an acrylate resin.

22. The article of claim 18 wherein the binder is present is a major amount of solids of the coating composition.

23. The article of claim 18 wherein the binder is present in an amount of greater that 15% by weight of the solids of the coating composition.

24. The article of claim 18 wherein the filler is inorganic.

25. The article of claim 18 wherein the filler is a silica, a clay, an alkaline earth metal sulfate or carbonate, an alkaline earth or transition metal oxide or hydroxide.

26. The article of claim 18 wherein the filler is present as a minor amount of the solids of the coating composition.
